(19) United States
(12) Patent Application Publication
(10) Pub. No.: US 2017/0096548 A1
(43) Pub. Date: Apr. 6, 2017

(54) HEAT INSULATION COMPOSITES HAVING AEROGEL WITH PRESERVING AEROGEL PORES USING VOLATILE SOLVENT AND METHOD FOR PREPARING THE SAME

(71) Applicant: KOREA INSTITUTE OF SCIENCE AND TECHNOLOGY, Seoul (KR)

(72) Inventors: Seong Yun KIM, Wanju-gun (KR); Hyun-Soo KIM, Wanju-gun (KR); Hun-su LEE, Wanju-gun (KR); Jaesang YU, Wanju-gun (KR); Yong Chae JUNG, Wanju-gun (KR); Jaewoo KIM, Wanju-gun (KR); Cheol-Min YANG, Wanju-gun (KR); Sang Jun YOUN, Wanju-gun (KR); Soon Ho LIM, Wanju-gun (KR)

(73) Assignee: KOREA INSTITUTE OF SCIENCE AND TECHNOLOGY, Seoul (KR)

(21) Appl. No.: 15/278,307

(22) Filed: Sep. 28, 2016

(30) Foreign Application Priority Data
Oct. 1, 2015 (KR) 10-2015-0138807

(51) Int. Cl. C08K 7/26; C08J 3/20; B01J 13/00; C01B 33/155; C01B 33/157

(52) U.S. Cl. CPC C08K 7/26; C01B 33/155; C01B 33/157; B01J 13/0091; C08J 3/203; C08J 2383/04; C08J 2363/00

(57) ABSTRACT

Provided is an aerogel-containing heat insulation composite obtained by providing a volatile material to the pores of the aerogel, blending the aerogel with a polymer resin, particularly a flexible polymer resin, to form a composite, and removing the volatile material. Thus, it is possible to prevent a decline of the porosity of the aerogel caused by infiltration and impregnation of the pores of the aerogel with the resin. As a result, the aerogel-containing heat insulation composite, particularly containing a high content of aerogel, may retain the heat insulation property of the aerogel as well as the flexibility of the plastic material.

### CROSS-REFERENCE TO RELATED APPLICATION

This application claims priority to Korean Patent Application No. 10-2015-0138807, filed on Oct. 1, 2015, and all the benefits accruing therefrom under 35 U.S.C. §119, the contents of which in its entirety are herein incorporated by reference.

### BACKGROUND

1. Field

The present disclosure relates to a heat insulation composite having an aerogel obtained by a method for preserving aerogel pores using a volatile solvent, particularly to a flexible heat insulation composite having an aerogel, and a method for preparing the same.

2. Description of the Related Art

An aerogel is a dry gel having a high porosity and was discovered when a silica aerogel was prepared first through a low-temperature sol-gel chemical process in the early 1930's by Kistler. As one solution for the recently issued global environmental problems, including global warming, an increase in oil price and regulation for carbon dioxide, many attentions have been given to a heat insulation material capable of saving energy efficiently. Under these circumstances, there has been an increasing interest in an aerogel, which has the lowest heat conductivity from the human historical point of view.

An aerogel including open porous nanoparticles with a size of 1-100 nm has a high specific surface area of 500-1200 m²/g, low dielectric constant of 1.1-2.0 and a low heat conductivity of 0.013-0.14 W/m·K. Such an aerogel having excellent heat insulation property may be utilized as insulation material for heat shielding in spaceships, nuclear reactors and vapor pipes. Therefore, there is a need for a technology of preparing various composites having heat insulation property by using an aerogel in various industrial fields.

Meanwhile, in the methods for preparing composites, composites having particles incorporated thereto may be obtained through different processes depending on the properties of raw materials and use, size and shape of a composite. Particularly, a melt compounding process is a typical process for forming various types of particle-incorporated composites. In such a melt compounding process, a resin is heated to a temperature of its melting point or higher so that it may be molten, and particles are incorporated thereto, followed by molding.

However, according to the studies of the present inventors, a particle-like or granule-like aerogel causes degradation of the structural safety of a composite due to its high porosity, and thus cannot be formed into a composite with ease. Particularly, as the content of aerogel incorporated to a composite is increased, the resultant composite has increased brittleness, thereby making it difficult to develop various types of products. Thus, it is a key technology to ensure the flexibility of an aerogel-containing composite in order to enhance commercialization of the composite. In addition, according to the studies of the present inventors, an aerogel can retain low heat conductivity only when the pores in the aerogel are preserved during the preparation of an aerogel composite. However, it is not easy to preserve the pores of an aerogel due to such a resin forming a composite.

### SUMMARY

The present disclosure is directed to providing an aerogel-containing heat insulation composite including a combination of an aerogel with a plastic material, wherein the aerogel-containing heat insulation composite is prevented from undergoing a decline of the porosity of the aerogel incorporated to the composite, caused by infiltration/impregnation of the pores of the aerogel with a resin, and thus may retain the heat insulation property of the aerogel (e.g., low heat conductivity of about 0.001-0.04 W/m·K), as well as a method for preparing the same.

The present disclosure is also directed to providing a flexible aerogel-containing heat insulation composite including a combination of an aerogel with a flexible plastic material, as well as a method for preparing the same. The flexible aerogel-containing heat insulation composite is prevented from undergoing a decline of structural stability, caused by incorporation of an aerogel, particularly a high content of aerogel, and an increase in brittleness of a composite, which, otherwise, makes a composite highly brittle under external impact so that it may not be processed into a product with ease. In the flexible aerogel-containing heat insulation composite, the pores of the aerogel incorporated to the composite are prevented from undergoing a decline of the porosity of the aerogel caused by infiltration/impregnation of the pores of the aerogel with a resin, and thus may retain the heat insulation property of the aerogel (e.g., low heat conductivity of about 0.001-0.04 W/m·K), while maintaining the flexibility of the plastic material.

In one aspect, there is provided an aerogel-containing heat insulation composite including an aerogel and a polymer resin, wherein the pores of the aerogel are preserved through treatment with a volatile material by providing the volatile material to the pores and then removing the volatile material.

In another aspect, there is provided a method for preparing an aerogel-containing composite, including: providing a volatile material to the pores of the aerogel; blending the aerogel with a polymer resin to form a composite; and removing the volatile material.

In still another aspect, there is provided a method for retaining the pores of an aerogel in an aerogel-containing composite, including: providing a volatile material to the pores of the aerogel; blending the aerogel with a polymer resin to form a composite; and removing the volatile material.

According to an embodiment, the polymer resin may be a flexible polymer resin.

According to some embodiments of the present disclosure, when preparing a composite by blending an aerogel with a plastic material, a decline of the porosity of the aerogel may be prevented, which decline is caused by infiltration/impregnation of the pores of the aerogel incorporated to the composite with a resin, and thus the heat insulation property of the aerogel (e.g., low heat conductivity of about 0.001-0.04 W/m·K) may be retained.

In addition, when an aerogel-containing heat insulation composite, particularly containing a high content of aerogel, is prepared, it is possible to prevent a problem of decrease of structural stability, which makes a composite highly brittle under external impact and difficult to be processed into a product with ease, caused by an increase in brittleness of the composite. It is also possible to prevent a decline of the porosity of the aerogel, caused by impregnation of the pores of the aerogel incorporated to the composite with a resin. As a result, the aerogel-containing heat insulation composite, particularly containing a high content of aerogel, may retain the heat insulation property of the aerogel (e.g., low heat conductivity of about 0.001-0.04 W/m·K) as well as the flexibility of the plastic material.

The aerogel-containing composite disclosed herein may be useful as heat insulation material in various industrial fields.

### BRIEF DESCRIPTION OF THE DRAWINGS

FIG. 1 is a schematic view illustrating the process for preparing an aerogel-containing composite, including agitating an aerogel with a volatile liquid, further agitating the resultant mixture with a polymer resin, and drying the resultant mixture to preserve the pores of the aerogel, according to an embodiment.

FIGS. 2A-2F show scanning electron microscopic (SEM) images of the composites obtained according to Example 1, Comparative Example 1 and Comparative Example 3.

FIG. 3 is an SEM image illustrating that the pores were preserved in the aerogel incorporated to the flexible aerogel-containing composite obtained by treatment with a volatile liquid according to Example 2.

FIG. 4 is a graph illustrating the heat conductivity of each of Example 1, Comparative Example 1 and Comparative Example 3 as a function of aerogel content.

FIG. 5A is a photograph illustrating the shape of the aerogel-containing composite obtained according to Example 2.

FIG. 5B is a photograph illustrating the flexibility of the aerogel-containing composite obtained according to Example 2.

### DETAILED DESCRIPTION

### Definition

As used herein, the expression ‘preserving the pores or porosity of an aerogel’ means preventing a decrease in pores (or porosity or pore volume) of an aerogel while the aerogel is blended with a polymer resin to form a composite.

As used herein, the expression ‘retaining flexibility’ means that a composite having an aerogel incorporated thereto maintains its flexibility as compared to the composite having no aerogel incorporated thereto. For reference, a composite generally undergoes a decrease of flexibility when a filler is incorporated thereto. However, after an aerogel is incorporated to the composite according to an embodiment, the composite maintains flexibility.

As used herein, ‘treatment with a volatile material’ means providing a volatile liquid to the pores of an aerogel, and then removing the volatile liquid.

### DETAILED DESCRIPTION OF EXEMPLARY EMBODIMENTS

Hereinafter, exemplary embodiments of the present disclosure will be described.

In one aspect, when an aerogel-containing composite (i.e. an aerogel-reinforced plastic) is prepared, a volatile material may be provided to the pores of the aerogel; and a polymer resin, particularly a flexible polymer resin may be blended therewith to form a composite, and then the volatile material may be removed.

Particularly, method of the above described may include: mixing an aerogel with a volatile material; and providing a polymer resin, particularly a flexible polymer resin, to the mixture of the aerogel with the volatile material to form a composite and removing the volatile material.

More particularly, the method may include: filling the pores of an aerogel with a volatile material; blending a polymer resin, particularly a flexible polymer resin, with the aerogel whose pores are filled, and curing the polymer resin to obtain a composite; and removing the volatile material.

Such volatile material functions as blocking agent to prevent infiltration of the polymer resin. In other words, before the polymer resin is cured, the pores of the aerogel may be infiltrated/impregnated with the polymer resin, thereby causing a significant decrease in porosity of the aerogel after forming a composite. However, when the volatile material is provided in the pores of the aerogel before the aerogel forms a composite with the polymer resin, it is possible to prevent the infiltration of the polymer resin into the pores of the aerogel.

According to an embodiment, the volatile material may be a volatile liquid, such as alcohol.

According to another embodiment, the aerogel may be silica aerogel or carbon aerogel.

According to still another embodiment, the polymer resin may be a curable polymer resin, such as epoxy resin.

According to still another embodiment, the polymer resin may be a flexible polymer resin. Particular examples of the flexible polymer resin may include a flexible epoxy, unsaturated polyester, polyurethane, teflon or silicone polymer resin. According to a non-limiting embodiment, the flexible polymer resin may be a polydimethylsiloxane (PDMS) polymer. Herein, the PDMS polymer may be a homopolymer or copolymer. The copolymer may be a block copolymer or graft copolymer. In addition, the flexible polymer resin may include polysilane, polycarbosilane, another silicone polymer-based modified resin (e.g. silicone rubber resin), or the like.

According to still another embodiment, the aerogel may be incorporated at a concentration of 0.1-20 wt % based on the total weight of the aerogel and the polymer resin in view of thermal conductivity. In the case of a flexible composite, the aerogel may be incorporated at a concentration of 10 wt %-20 wt % in view of thermal conductivity and flexibility. Such aerogel content may be controlled within the above-defined range considering the property, thermal conductivity and flexibility of a composite.

According to still another embodiment, agitation may be carried out during the mixing of the aerogel with the volatile material or during the formation of the composite.

According to still another embodiment, when removing the volatile material, natural evaporation or heating and drying of the volatile material may be carried out. Although there is no particular limitation in time/temperature of the evaporation or drying, the heating and drying temperature may be selected so that it is equal to or higher than the vaporization temperature of the volatile material. In addition, the drying may be carried out for 200 hours or less, or for 100 hours or less.

The obtained composite includes the aerogel and polymer resin, particularly flexible polymer resin, and is a heat insulation composition, particularly a flexible heat insulation composite having an aerogel treated with a volatile material that is provided to the pores of the aerogel and then removed.

The composite may be prevented from a decline of the porosity of the aerogel, caused by infiltration/impregnation of the pores of the aerogel incorporated to the composite with a resin. Thus, it is possible to maintain the heat insulation property of the aerogel (e.g. a thermal conductivity as low as 0.001-0.04 W/m·K). In addition, in the case of a flexible composite, it includes a flexible resin even when an aerogel is incorporated to the composite, particularly in a large amount (e.g. 10 wt % or more). Therefore, it is possible to prevent a problem of decrease of structural stability caused by an increase in brittleness of the composite, and thus to maintain flexibility. Such a flexible polymer resin, such as PDMS, may have high shape stability and flexibility even in the presence of pores by virtue of its unique flexible molecular structure, unlike general resins.

According to still another embodiment, the aerogel of the heat insulation composition may retain at least 90 vol % or at least 99 vol % of the pore volume of the aerogel before blended with a polymer resin. The pore volume of the composite may be controlled considering the property, thermal conductivity and/or flexibility of the composite. However, it can be desirable for the porosity of the aerogel to be maintained at a degree of at least 90 vol % or at least 99%, as compared to the aerogel before blended with the polymer resin.

According to still another embodiment, the heat insulation composite may have substantially the same thermal conductivity as the aerogel before incorporated to the composite (a difference of 5% or less).

According to still another embodiment, the heat insulation composite may have a thermal conductivity of 0.04 W/m·K or less, particularly 0.02 W/m·K or less or 0.01 W/m·K or less. According to a non-limiting embodiment, the heat insulation composite may have a thermal conductivity of 0.001-0.04 W/m·K.

Meanwhile, in another aspect, there is provided a method for retaining the pores of an aerogel in an aerogel-containing composite, including: providing a volatile material to the pores of the aerogel; and blending a polymer resin, particularly a flexible polymer resin, therewith to form a composite, and removing the volatile material.

Hereinafter, the present disclosure will be described in detail through examples. However, the following examples are for illustrative purposes only and it will be apparent to those of ordinary skill in the art that the scope of the present disclosure is not limited by the examples.

### Examples 1-2 and Comparative Examples 1-2

### Preparation of Materials

To provide an aerogel-containing composite, silica aerogel powder available from Empower Co., Ltd. was prepared. Particularly, the method for preparing the silica aerogel is as follows. Water glass was used as starting material and distilled water was used to provide a silica sol having a silica content of 29 wt %. To carry out surface modification and gelling, a co-precursor process in which hexamethyldisilazane and nitric acid are added to the silica sol was used. The hydrogel obtained by the co-precursor process was dipped in n-hexane at 60° C. for 10 hours to carry out solvent exchange and ion removal. Then, the modified gel was dried under atmospheric pressure at 170° C. for 20 minutes and at 200° C. for 10 minutes.

The physical properties of the resultant aerogel are shown in the following Table 1.

In addition, a polydimethylsiloxane resin composition (PDMS resin+curing agent) (Dow Corning, Sylgard 184 A (resin) and B (curing agent)) was prepared. Further, an epoxy resin composition (epoxy resin+curing agent) (Kukdo Chemical Co., Ltd., YD 128, curing agent: IPDA) was prepared.

TABLE 1

| | | | |
|---|---|---|---|
| Thermal conductivity | 0.02 W/m · K | Density | 0.05 g/cm³ |
| Thermal stability | −200° C. to 450° C. | Porosity | 90% |
| Particle distribution | 1-10 μm (>95%) | Pore | <20 nm |
| | | distribution | (Average: |
| | | | 9 nm) |

Preparation of Aerogel-Containing Composite

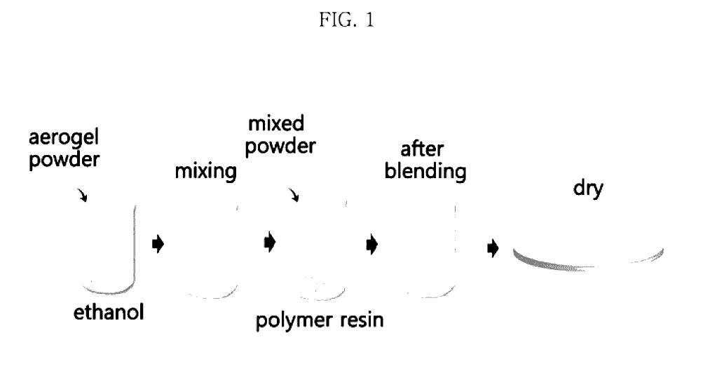

FIG. 1 is a schematic view illustrating the process for preparing an aerogel-containing composite, including agitating an aerogel with a volatile liquid, further agitating the resultant mixture with a polymer resin (e.g. PDMS, epoxy), and drying the resultant mixture to obtain an aerogel-containing composite (aerogel/epoxy: Example 1) and a flexible aerogel-containing composite (aerogel/PDMS: Example 2) in which the pores of the aerogel are preserved according to some embodiments.

As shown in FIG. 1, the aerogel and ethanol as volatile liquid were introduced to a beaker and agitated with a glass stirrer at room temperature under ambient pressure.

The agitated materials were further agitated thoroughly with the above-mentioned epoxy resin composition (Example 1) or with the polydimethylsiloxane (PDMS) resin composition (Example 2).

The composite agitated with ethanol as mentioned above was poured to a mold provided for forming a specimen.

Then, the composite was dried sufficiently by allowing it to stand at room temperature for 24 hours in order to induce the curing of the thermosetting polymer resin, epoxy (Example 1) or polydimethylsiloxane (PDMS) (Example 2) and evaporation of the volatile liquid. After that, the composite was further dried in an oven at 80° C. to induce the vaporization of the volatile liquid.

In the case of the composite using an epoxy resin according to Example 1, the aerogel was used in a different amount of 25 vol %, 50 vol % or 75 vol % based on the total volume of the composite.

To form the specimens of control group (Comparative Example 1) for Example 1, specimens having no ethanol incorporated thereto and not treated with ethanol were prepared. Similarly, in the case of Comparative Example 1, the aerogel was used in a different amount of 25 vol %, 50 vol % or 75 vol % based on the total volume of the composite.

In the case of the flexible composite using polydimethylsiloxane according to Example 2, specimens were prepared by using the aerogel at a different weight ratio of 3 wt %, 6 wt %, 9 wt % or 12 wt % based on the weight of the composite.

Meanwhile, to form the specimens of control group (Comparative Example 2) for Example 2, the aerogel was agitated thoroughly with polydimethylsiloxane (PDMS) resin, while no ethanol was incorporated thereto (i.e., not treated with a volatile liquid).

The agitated composite was poured adequately to a mold provided for forming a specimen.

Then, the polymer resin was cured and allowed to stand at room temperature for 24 hours to carry out drying.

### Comparative Example 3

Aerogel powder was treated with plasma while not treated with ethanol as volatile liquid, and was used to obtain a composite with an epoxy resin (Comparative Example 3). It is known that such plasma treatment modifies the aerogel structure, such as particle size or surface area, and thus reduces thermal conductivity (See Macromolecular Research 22 108-111, 2014 (referring to Non-Patent Documents 1) and Journal of Non-Crystalline Solids 355 2610-2615, 2009 (referring to Non-Patent Documents 2)). Therefore, Comparative Example 3 is directed to comparing the effect of treatment with a volatile liquid according to an embodiment of the present disclosure with the effect of plasma treatment.

First, silica aerogel powder was treated with plasma (Model BD-10AV, Electro-Technic Products Inc., Chicago, Ill., USA) and the plasma-treated aerogel was blended with an epoxy resin composition and subjected to curing in the same manner as Example 1, thereby providing a composite. Also in the case of Comparative Example 3, the plasma-treated aerogel was used in a different amount of 25 vol %, 50 vol % or 75 vol % based on the total volume of the composite.

Characterization

(1) Pore Characterization

The aerogel-containing composites obtained as described above were determined for their microstructures through the images taken by a scanning electron microscope (FEI Co., Ltd., USA, FE-SEM, Nova NanoSEM 450 Model).

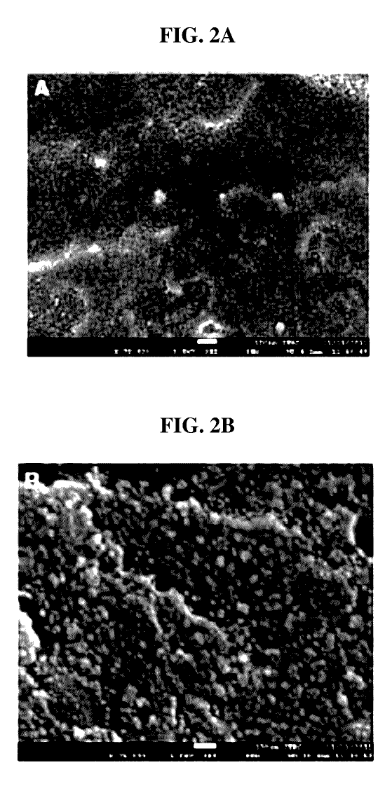

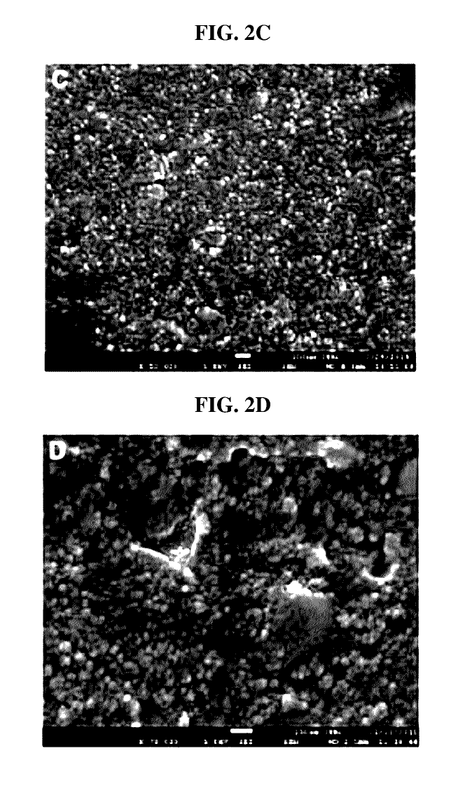

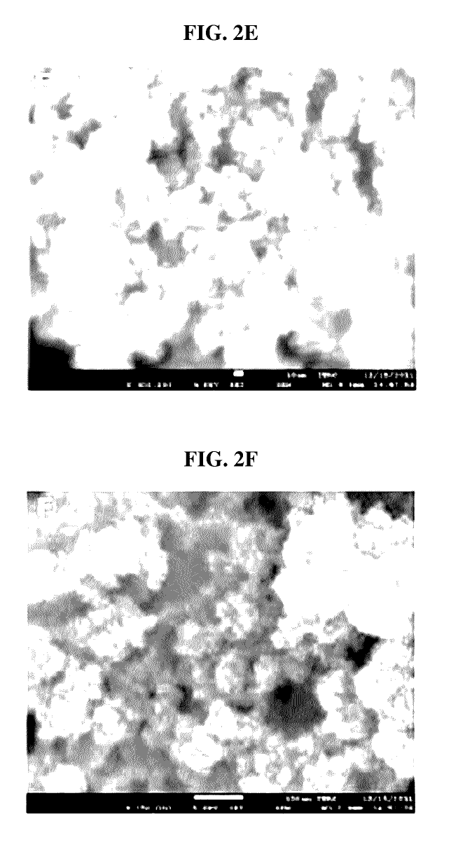

FIGS. 2A-2F shows scanning electron microscopic (SEM) images of the composites obtained according to Example 1, Comparative Example 1 and Comparative Example 3.

FIG. 2A and FIG. 2B show the composite not subjected to any treatment according to Comparative Example 1, wherein FIG. 2A corresponds to the composite using 25 vol % of aerogel and FIG. 2B corresponds to the composite using 75 vol % of aerogel. FIG. 2C and FIG. 2D show the composite treated with plasma according to Comparative Example 3, wherein FIG. 2C corresponds to the composite using 25 vol % of aerogel and FIG. 2D corresponds to the composite using 75 vol % of aerogel. FIG. 2E and FIG. 2F show the composite treated with ethanol as volatile liquid according to Example 1, wherein FIG. 2E corresponds to the composite using 25 vol % of aerogel and FIG. 2F corresponds to the composite using 75 vol % of aerogel.

As shown in FIGS. 2A-2F, the aerogel incorporated to the aerogel-containing composite according to Example 1 retained the pores inside thereof better as compared to Comparative Examples 1 and 3.

The following Table 2 shows the BET results including the pore volume, pore size, surface area, density and porosity of each of the composites according to Example 1 and Comparative Example 1 as a function of aerogel volume ratio.

TABLE 2

| | Pore | | | | |
|---|---|---|---|---|---|
| | volume | Pore size | Surface area | Density | Porosity |
| | (mL/g) | (nm) | (m²/g) | (g/mL) | (%) |
| Comp. Ex. 1 | 0 | — | 0 | 1.11 | 0 |
| 25 vol % | | | | | |
| Comp. Ex. 1 | 0 | — | 0 | 1.11 | 0 |
| 50 vol % | | | | | |
| Comp. Ex. 1 | 0 | — | 0 | 1.12 | 0 |
| 75 vol % | | | | | |
| Ex. 1 | 6.3 | 3-30 | 122.84 | 0.91 | 18.1 |
| 25 vol % | | (Average 8.2) | | | |
| Ex. 1 | 12.5 | 3-30 | 245.68 | 0.81 | 35.7 |
| 50 vol % | | (Average 8.4) | | | |
| Ex. 1 | 19.2 | 3-30 | 368.52 | 0.73 | 54.8 |
| 75 vol % | | (Average 8.1) | | | |

As can be seen from Table 2, in the case of the composite not treated with any treatment according to Comparative Example 1, the pore volume became 0 due to the infiltration of the polymer resin into the pores, even when the composite contains a large amount of aerogel. On the contrary, in the case of the composite treated with a volatile liquid according to Example 1, the pore volume and porosity were increased significantly as the aerogel content is increased. This demonstrates that treatment with a volatile liquid prevents infiltration of the polymer resin into the pores, and thus preserves the pores.

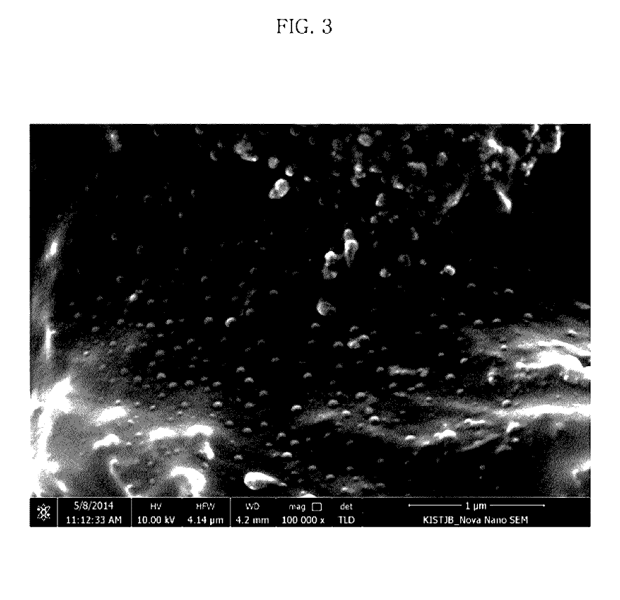

Meanwhile, FIG. 3 is an SEM image illustrating that the pores were preserved in the aerogel incorporated to the aerogel-containing composite obtained by treatment with a volatile liquid according to Example 2.

As shown in FIG. 3, the pores of the aerogel incorporated to the composite were preserved well in the aerogel-containing composite obtained according to Example 2.

(2) Determination of Thermal Conductivity

The aerogel-containing composites obtained as described above were determined for their heat conductivities by using a thermal conductivity analyzer (KATO TECH Co., Ltd., Japan, Thermo Labo II-KES-F7 Model). The determination was carried out in the manner as described hereinafter.
A hot plate (solid copper plate) having an area of 9 cm², a weight of 9.79 g and a heat capacity of 4.186×103 JK⁻¹ m⁻² generates heat.
The upper surface of a sample is in contact with the hot plate so that the calorie stored in the hot plate is transferred to the sample having a low temperature.
The value measured at 0.2 seconds after the contact is the peak value of heat transfer, qₘₐₓ.
qₘₐₓ is in proportion to the temperature difference between the hot plate temperature and the sample temperature and to the contact pressure.
The standard condition used herein includes 10 gf/cm³ when the plate is 90 g and the contact area is 9 cm².

Thus, the determination was carried out as follows.
(i) A water box is set to room temperature.
(ii) A sample having a size of 5×5 cm is disposed on the water box and a hot plate is positioned on the upper surface of the sample.
(iii) After a predetermined value is obtained, the heat flow loss, W, of the hot plate is read.

$$W = K \cdot \frac{A \cdot Δ T}{D}$$

D: Thickness of sample (cm)

A: Area of B.T. heat plate (cm²)

ΔT: Temperature difference of sample (° C.)

K: Thermal Conductivity
(iv) Thermal conductivity, K is defined as follows based on the above formula.

$$K = \frac{W \cdot D}{A Δ T} ( W \text{/} cm °C . )$$

Herein, the contact pressure is set to 6 g/cm² and the temperature of the hot plate is controlled within an error range smaller than 0.1° C.

The results of determination of thermal conductivity according to the above method are shown hereinafter.

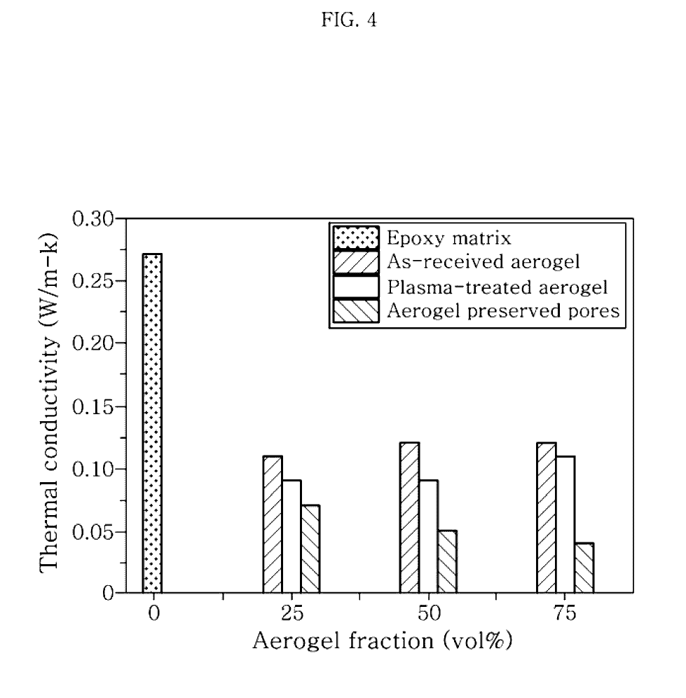

FIG. 4 is a graph illustrating the heat conductivity of each of Example 1, Comparative Example 1 and Comparative Example 3 as a function of aerogel content. The results are also shown in the following Table 3.

TABLE 3

| | | | Thermal conductivity |
|---|---|---|---|
| | Epoxy | Plasma treatment | of composite |
| Aerogel (Vol %) | (Vol %) | for aerogel | (W/m · K) |
| Comp. Ex. 1 | 75 | X | 0.112 |
| (25 vol %) | | | |
| Comp. Ex. 1 | 50 | X | 0.123 |
| (50 vol %) | | | |
| Comp. Ex. 1 | 25 | X | 0.113 |
| (75 vol %) | | | |
| Comp. Ex. 3 | 75 | ◯ | 0.085 |
| (25 vol %) | | | |
| Comp. Ex. 3 | 50 | ◯ | 0.087 |
| (50 vol %) | | | |
| Comp. Ex. 3 | 25 | ◯ | 0.110 |
| (75 vol %) | | | |
| Ex. 1 | 75 | X | 0.072 |
| (25 vol %) | | | |
| Ex. 1 | 50 | X | 0.054 |
| (50 vol %) | | | |
| Ex. 1 | 25 | X | 0.040 |
| (75 vol %) | | | |

As can be seen from FIG. 4 and Table 3, the aerogel/epoxy composite according to Comparative Example 1 showed a thermal conductivity of 0.112 W/m·K to 0.123 W/m·K, which is smaller than the thermal conductivity of the epoxy resin used therefor (0.27 W/m·K) but is significantly larger than the thermal conductivity of the aerogel (0.02 W/m·K). This is because the epoxy resin infiltrates into the pores of the aerogel so that the resultant composite may have a decreased porosity.

Meanwhile, it is possible to treat the aerogel with plasma, like in the case of Comparative Example 3, to control the pore size of the aerogel to a smaller size so that the infiltration of the epoxy resin into the pores may be prevented partially. However, the plasma-treated aerogel/epoxy composite showed a thermal conductivity of 0.085 W/m·K to 0.11 W/m·K. For reference, such results have been disclosed in Non-Patent Documents 1 and 2. The above thermal conductivity of the composite is still higher as compared to the thermal conductivity of the aerogel (0.02 W/m·K).

On the contrary, in the case of Example 1 treated with a volatile liquid, it showed the lowest thermal conductivity as compared to Comparative Examples 1 and 3, and the thermal conductivity of the composite was decreased as the aerogel content is increased.

Therefore, it can be seen that the composite treated with a volatile liquid according to some embodiments of the present disclosure is the most effective for reducing thermal conductivity.

Meanwhile, the thermal conductivity of the aerogel-containing composite obtained from Example 2 is shown in the following Table 4. In addition, Table 4 shows the thermal conductivity of the control group (Comparative Example 2) not treated with ethanol as volatile liquid.

TABLE 4

| | Incorporation of | | |
|---|---|---|---|
| | ethanol and | Weight | Thermal |
| | additional drying | content of | conductivity of |
| Specimen | at 80° C. | aerogel (%) | composite (W/m · K) |
| 1 | X | 0 | 0.149 |
| (Comp. Ex. 2) | | | |
| 2 | X | 3 | 0.148 |
| (Comp. Ex. 2) | | | |
| 3 | X | 6 | 0.163 |
| (Comp. Ex. 2) | | | |
| 4 | X | 9 | 0.165 |
| (Comp. Ex. 2) | | | |
| 5 | X | 12 | 0.176 |
| (Comp. Ex. 2) | | | |
| 6 | ◯ | 3 | 0.145 |
| (Ex. 2) | | | |
| 7 | ◯ | 6 | 0.102 |
| (Ex. 2) | | | |
| 8 | ◯ | 9 | 0.077 |
| (Ex. 2) | | | |
| 9 | ◯ | 12 | 0.018 |
| (Ex. 2) | | | |

Example 2 also demonstrates that treatment with a volatile liquid is effective for reducing thermal conductivity when forming a composite.

(3) Observation of Shape and Flexibility of Flexible Composite (Example 2)

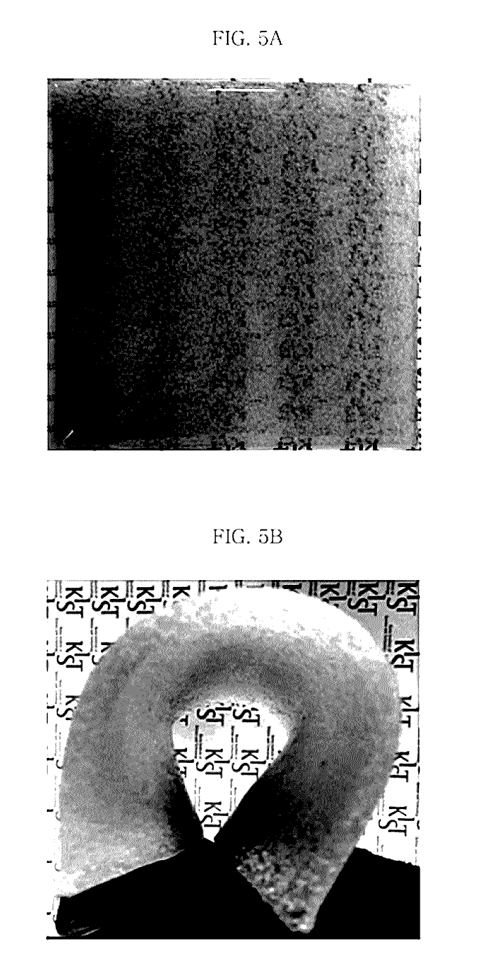

FIG. 5 is photographs illustrating the shape (FIG. 5A) and flexibility (FIG. 5B) of the aerogel-containing composite obtained according to Example 2.

As can be seen from FIG. 5, the aerogel-containing composite obtained from Example 2 not only has low thermal conductivity (preservation of porosity), but also undergoes no deformation and retains its flexibility (or structural stability) without breakage even when bent at a degree of 90° or more.

Analysis of Results

As described above, it can be seen from the thermal conductivity of each of Example 1 and Comparative Examples 1 and 3 that treatment with a volatile liquid is significantly effective for preserving the pores of an aerogel and providing low thermal conductivity when a composite is formed. Particularly, even when the incorporation amount of an aerogel is increased, treatment with a volatile liquid provides lower thermal conductivity.

In addition, as can be seen from Example 2 and Comparative Example 2, the aerogel/PDMS composite (Comparative Example 2) whose pores are not preserved due to the lack of treatment with a volatile liquid showed thermal conductivity similar to the thermal conductivity of PDMS resin and significantly higher than the thermal conductivity of the aerogel/PDMS composite (Example 2) whose pores are preserved by virtue of treatment with a volatile liquid, as demonstrated by Table 2.

The lowest thermal conductivity of the aerogel/PDMS composite according to Example 2 is 0.02 W/m·K or less, which is equivalent to the thermal conductivity of the aerogel before it forms a composite. This suggests that the thermal conductivity of the aerogel is maintained even when it forms a composite.

This is because the pores of the aerogel are filled with volatile ethanol according to the above-described method for preparing an aerogel-containing composite, polydimethylsiloxane (PDMS) cannot infiltrate into the pores of the aerogel during the curing of the composite, and the volatile material is evaporated and vaporized during the drying and heat treatment after curing, so that the aerogel may retain its porosity and the composite may retain low thermal conductivity.

The above description does not conform to the general rule of mixture. Even though the aerogel formed a composite together with PDMS having a thermal conductivity at least 10 times higher than the thermal conductivity of the aerogel, the composite retained low thermal conductivity, suggesting that the pores are preserved well in the aerogel. Additionally, it is because the thermal interface resistance generated when introducing a nano-scaled material causes a delay in transfer of phonon that is a main medium of heat transfer.

As can be seen from the foregoing, when forming a composite according to the method disclosed herein, it is easy to control the ratio of an aerogel to a polymer resin (according to an embodiment, polydimethylsiloxane (PDMS) and epoxy) and the reaction conditions (temperature and agitation). In addition, the volumetric proportion of the aerogel and the porosity of the finished composite may be controlled with ease. Particularly, even after being used for forming a composite, it is possible to retain the low thermal conductivity of the aerogel itself. More particularly, when using a flexible polymer resin, it is possible to retain the flexibility of the flexible polymer resin.

What is claimed is:

1. An aerogel-containing heat insulation composite comprising an aerogel and a polymer resin, wherein the pores of the aerogel are preserved through treatment with a volatile material by providing the volatile material to the pores of the aerogel and removing the volatile material.

2. The aerogel-containing heat insulation composite according to claim 1, wherein the polymer resin is a flexible polymer resin, and the heat insulation composite is a flexible heat insulation composite.

3. The aerogel-containing heat insulation composite according to claim 2, which retains flexibility as compared to the composite having no aerogel incorporated thereto.

4. The aerogel-containing heat insulation composite according to claim 1, wherein the pores of the aerogel are prevented from infiltration of the polymer resin by virtue of the volatile material provided in the pores.

5. The aerogel-containing heat insulation composite according to claim 1, which has a pore volume or porosity increased according to an increase in aerogel content.

6. The aerogel-containing heat insulation composite according to claim 1, which has a thermal conductivity decreased according to an increase in aerogel content.

7. The aerogel-containing heat insulation composite according to claim 1, wherein the aerogel in the composite retains its pore volume to at least 90 vol % or at least 99 vol % as compared to the pore volume of the aerogel before blended with the polymer resin.

8. The aerogel-containing heat insulation composite according to claim 1, which shows a thermal conductivity different from the thermal conductivity of the aerogel itself before incorporated into the composite by 5% or less.

9. The aerogel-containing heat insulation composite according to claim 1, which has a thermal conductivity of 0.04 W/m·K or less.

10. The aerogel-containing heat insulation composite according to claim 2, wherein the aerogel is silica aerogel or carbon aerogel, and the flexible polymer resin is at least one selected from the group consisting of polydimethylsiloxane (PDMS) polymer, polysilane and polycarbosilane.

11. The aerogel-containing heat insulation composite according to claim 1, wherein the aerogel is present in an amount of 0.1-20 wt % based on the total weight of the composite.

12. A method for preparing an aerogel-containing heat insulation composite, comprising:
providing a volatile material to the pores of the aerogel and blending the aerogel with a polymer resin to form a composite; and
removing the volatile material.

13. The method for preparing an aerogel-containing heat insulation composite according to claim 12, wherein the polymer resin is a flexible polymer resin, and the heat insulation composite is a flexible heat insulation composite.

14. The method for preparing an aerogel-containing heat insulation composite according to claim 12, which comprises:
mixing the aerogel with the volatile material; and
providing the polymer resin to the mixture of the aerogel with the volatile material to form a composite and removing the volatile material.

15. The method for preparing an aerogel-containing heat insulation composite according to claim 12, which comprises:
filling the pores of the aerogel with the volatile material;
blending the polymer resin with the aerogel whose pores are filled and curing the polymer resin to form a composite; and
removing the volatile material.

16. The method for preparing an aerogel-containing heat insulation composite according to claim 15, wherein the aerogel is mixed and agitated with the volatile material so that the pores of the aerogel are filled with the volatile material.

17. The method for preparing an aerogel-containing heat insulation composite according to claim 16, wherein agitation is carried out while the aerogel whose pores are filled with the volatile material is blended with the polymer resin.

18. The method for preparing an aerogel-containing heat insulation composite according to claim 17, wherein heating and drying are carried out at a temperature of the vaporization temperature of the volatile material or higher, after evaporating the volatile material.

19. The method for preparing an aerogel-containing heat insulation composite according to claim 12, wherein the polymer resin is cured, and the volatile material present in the pores of the aerogel before curing prevents infiltration of the polymer resin into the pores of the aerogel.

20. The method for preparing an aerogel-containing heat insulation composite according to claim 12, wherein the volatile material is an alcohol.
